(19) United States
(12) Patent Application Publication
(10) Pub. No.: US 2012/0293744 A1
(43) Pub. Date: Nov. 22, 2012

(54) LIGHT GUIDE SHEET AND DISPLAY DEVICE

(75) Inventor: Hisashi Watanabe, Osaka-shi (JP)

(73) Assignee: Sharp Kabushiki Kaisha, Osaka-shi, Osaka (JP)

(21) Appl. No.: 13/522,792

(22) PCT Filed: Jan. 27, 2011
(86) PCT No.: PCT/JP2011/051627

§ 371 Date: Jul. 18, 2012

(30) Foreign Application Priority Data
Jan. 28, 2010 (JP) 2010-016808

(51) Int. Cl. G02F 1/1335; G02B 6/26; G02B 6/10

(52) U.S. Cl. 349/62; 385/129; 385/31

(57) ABSTRACT

A light guide sheet (20A) in a display device (100a) according to the present invention includes a light guide element (21A) and a light-transmitting cover sheet (26a). The light guide element has a light-receiving surface (21a) and a side face (21c) which are parallel to a first direction and substantially orthogonal to each other, and an outgoing surface (21b) being formed between the light-receiving surface and the side face and constituting an acute angle with the light-receiving surface. The light-transmitting cover sheet has first and second principal faces which are parallel to the first direction and parallel to each other, and a first side face being formed between the first principal face and the second principal face and constituting an acute angle with the second principal face. The first side face of the light-transmitting cover sheet and the outgoing surface of the light guide element are coupled to each other via an adhesion layer (24a), and an angle between the outgoing surface and first side face of the transparent cover sheet is equal to an angle between the incident surface and outgoing surface of the light guide element. The light guide sheet is substantially plate-like, and the light-receiving surface (21a) of the light guide element and the light-receiving surface of the light-transmitting cover sheet are connected via a level difference of 10 μm or less.

### TECHNICAL FIELD

The present invention relates to a display device having a light guide sheet and a light guide sheet.

### BACKGROUND ART

In recent years, there is a strong desire for an increase in the size of television sets and display devices for displaying information. Representative examples of large-sized display devices are display devices in which self-light-emitting elements such as light-emitting diodes (LEDs) are arranged in a matrix array and projection display devices; however, these have disadvantages in terms of image quality. Therefore, a further increase in the size of direct-viewing type liquid crystal display devices (LCDs) and plasma display devices (PDPs), which are capable of displaying with a high image quality, is being desired.

Since a direct-viewing type liquid crystal display device or a plasma display device is basically formed on a glass substrate, its screen size depends on the substrate size. Currently, the largest of glass substrates (mother substrates) that are used for the production of liquid crystal display devices are those of the eighth generation (2200 mm×2400 mm), and liquid crystal display devices whose diagonal is about 100 inches are being produced by using these substrates. The substrates that are available for mass production will become more increased in size, however at a slow rate. It is difficult to immediately provide display devices with the larger areas that are required on the current market.

Therefore, as a method of realizing a large-screen display device, there has been a conventional attempt of realizing a make-believe large-screen display device by arraying a plurality of display devices (which may be referred to as tiling). However, the tiling technique induces a problem of visible joints between the plurality of display devices. This problem will be described by taking a liquid crystal display device for example.

Note that a liquid crystal display device mainly includes a liquid crystal display panel, a backlight device, circuits for supplying various electrical signals to the liquid crystal display device, and a power supply, as well as a housing in which to accommodate these. The liquid crystal display panel is mainly composed of a pair of glass substrates and a liquid crystal layer retained therebetween. On one of the glass substrates, a color filter layer and a counter electrode are formed, while on the other glass substrate, TFTs, bus lines, a driving circuit for supplying signals to them, and the like are formed. The screen size of a direct-viewing type liquid crystal display device is determined by the screen size of its liquid crystal display panel. Moreover, the liquid crystal display panel has a display region composed of a plurality of pixels, and a frame region surrounding it. In the frame region, a sealing portion for attaching together the pair of substrates and also sealing and retaining the liquid crystal layer, an implementation of driving circuitry for driving the pixels, and the like are formed.

Thus, since the frame region not contributing to any displaying exists in a liquid crystal display panel, when a large screen is constructed by arraying a plurality of liquid crystal display panels, the image will have joints. This problem is not limited to liquid crystal display devices, but is shared among direct-viewing type display devices, e.g., PDPs, organic EL display devices, and electrophoresis display devices.

Patent Document 1 discloses a construction which includes an optical fiber face plate covering the entire display panel, such that jointless displaying is performed by allowing the light going out from a display region to be guided to a non-display region by the optical fiber face plate.

Patent Document 2 discloses a construction in which an optical fiber face plate complex is provided on the entire display panel, such that jointless displaying is performed by allowing the light going out from a display region to be guided to a non-display region by the optical fiber face plate.

Patent Document 3 discloses a construction including an optical compensation means over substantially the entire display panel, the optical compensation means being composed of a multitude of slanted thin films and a transparent material filled between the slanted thin films, such that jointless displaying is performed by allowing light to be guided to a non-display region by the optical compensation means.

Since an optical fiber face plate is an aggregate of optical fibers, it becomes increasingly difficult and costing to produce as it increases in area. The conventional techniques described in Patent Document 1 and Patent Document 2 require an optical fiber face plate covering substantially the entire display panel, and thus are not practical from the standpoint of the production method and cost particularly in large-sized display devices.

The technique described in Patent Document 3 differs from the techniques of Patent Documents 1 and 2 in that an optical compensation means composed of a multitude of slanted thin films and a transparent material filled between the slanted thin films is used, instead of an optical fiber face plate. However, it still requires the optical compensation means covering substantially the entire display panel, thus presenting problems similar to those of the techniques described in Patent Document 1 and Patent Document 2.

Note that Patent Document 2 states that a parallel plate (a fiber face plate whose light-receiving face and outgoing face are parallel) to be disposed in the display region is omissible. However, when the parallel plate is omitted, an end face portion of a block-like (having a rectangular cross section) optical fiber face plate that is disposed at an edge portion of the display region forms a stepped portion within the display region, thus rendering the image discontinuous and detracting from display quality.

Accordingly, the Applicants disclose in Patent Document 4 a display device which is easier to produce than conventionally, or which incurs a lower cost than conventionally, in which frame regions of display panels, or a joint in the case of tiling, are obscured.

The display device described in Patent Document 4 includes a light guide element which is disposed so as to overlaps a frame region and part of a peripheral display region of a display panel adjoining the frame region. The light guide element has a light-receiving surface at which light enters, and an outgoing surface, with a plurality of light guide paths being formed between the light-receiving surface and the outgoing surface. The light-receiving surface is disposed parallel to the surface of the display panel, and the outgoing surface is disposed so that its distance from the light-receiving surface increases away from the peripheral display region and toward the frame region. A cross-sectional shape (in a plane perpendicular to the light-receiving surface and the outgoing surface) of the light guide element is typically a triangle. Moreover, Patent Document 4 discloses a display device which further includes a light-transmitting cover that covers the outgoing surface of the light guide element.

In the display device described in Patent Document 4, the light guide element only overlaps part of the peripheral display region of the display panel and the frame region, and no light guide element exists in a large portion of the display region excluding that part of the peripheral display region. This provides advantages of ease of production and low cost because an optical fiber face plate having a large area is not required, unlike in the display devices of Patent Documents 1 to 3. The entire disclosure of Patent Document 4 is incorporated herein by reference.

### CITATION LIST

### Patent Literature

[Patent Document 1] Japanese Laid-Open Patent Publication No. 7-128652
[Patent Document 2] Japanese Laid-Open Patent Publication No. 2000-56713
[Patent Document 3] Japanese Laid-Open Patent Publication No. 2001-5414
[Patent Document 4] International Publication No. 2009/122691

### SUMMARY OF INVENTION

### Technical Problem

However, upon considering mass production of its prototypes, the inventors have found a problem in that the overall shape of the light guide element used in the display device described in Patent Document 4, which is a triangular prism, is difficult to produce with a high dimensional accuracy, or that chipping is likely to occur in corner portions. A light-transmitting cover provided so as to cover the outgoing surface of the light guide element also has similar problems. It is also difficult for the light guide element and the light-transmitting cover to be attached together with a high accuracy.

The present invention has been made in order to solve the above problems, and a main objective thereof is to provide a display device which is easier to produce than the display device described in Patent Document 4, in which frame regions of display panels, or a joint in the case of tiling, are obscured. Another objective of the present invention is to provide a light guide sheet to be used in such a display device, as well as a production method thereof.

### Solution to Problem

A light guide sheet according to the present invention is a light guide sheet comprising: a light guide element having a first face and a second face which are parallel to a first direction and substantially orthogonal to each other, a third face being formed between the first face and the second face and constituting an acute angle with the first face, and a fourth face and a fifth face which are substantially orthogonal to the first face, the second face, and the third face, the light guide element having a plurality of light guide paths formed between the first face and the second face and third face; and a light-transmitting cover sheet having a first principal face and a second principal face which are parallel to the first direction and parallel to each other, a first side face which is a side face being formed between the first principal face and the second principal face and constituting an acute angle with the second principal face, and a second side face and a third side face which are substantially orthogonal to the first principal face, the second principal face, and the first side face, wherein, the light guide sheet has a substantially plate-like shape; the third face of the light guide element and the first side face of the light-transmitting cover sheet are coupled to each other via an adhesion layer; an angle between the first face and the third face of the light guide element is equal to an angle between the second principal face and the first side face of the light-transmitting cover sheet; and the first face of the light guide element and the first principal face of the light-transmitting cover sheet are connected via a level difference of 10 μm or less.

In one embodiment, the first face of the light guide element and the first principal face of the light-transmitting cover sheet have bumps and dents of 1 μm or more.

In one embodiment, the second principal face of the light-transmitting cover sheet has bumps and dents of 1 μm or more.

In one embodiment, one of the fourth face and fifth face of the light guide element and the second side face of the light-transmitting cover sheet are connected via a level difference of 10 μm or less, and the other of the fourth face and fifth face of the light guide element and the third side face of the light-transmitting cover sheet are connected via a level difference of 10 μm or less.

Another light guide sheet according to the present invention comprises two sub-light guide sheets, wherein, each of the two sub-light guide sheets is any of the above light guide sheets, having a fourth side face substantially orthogonal to the first principal face and the second principal face; and the fourth side faces of the two sub-light guide sheets are coupled to each other via an adhesion layer.

A display device according to the present invention comprises: any of the above light guide sheets; and a display panel having a display region and a frame region formed outside the display region, wherein the first face of the light guide element is disposed so as to overlap a portion of a peripheral display region and be parallel to an outgoing surface of the display panel, the peripheral display region adjoining the frame region of the display panel along a second direction which is orthogonal to the first direction.

In one embodiment, the first face of the light guide element and the first principal face of the light-transmitting cover sheet have bumps and dents of 1 μm or more; and the light guide sheet and the display panel are coupled to each other via an adhesion layer.

In one embodiment, the second principal face of the light-transmitting cover sheet has bumps and dents of 1 μm or more; the display device further comprises a transparent front face plate disposed on a viewer's side of the light guide sheet; and the light guide sheet and the transparent front face plate are coupled to each other via an adhesion layer.

In one embodiment, the at least one display panel has a plurality of pixels arrayed at a predetermined pitch across the entire display region; and display signals to be supplied to a number of pixels existing in the portion of the peripheral display region are compressed along the second direction.

### Advantageous Effects of Invention

According to the present invention, there is provided a display device which is easier to produce than the display device described in Patent Document 4, in which frame regions of display panels, or a joint in the case of tiling, are obscured. Also according to the present invention, there is provided a light guide sheet to be used in such a display device, as well as a production method thereof.

### BRIEF DESCRIPTION OF DRAWINGS

FIG. 1 A schematic cross-sectional view of a liquid crystal display device 100a according to an embodiment of the present invention.

FIG. 2 A schematic cross-sectional view of an end portion of the liquid crystal display device 100a.

FIGS. 3 (a) and (b) are cross-sectional views schematically showing laminate structures of light guide layers to be used for producing a light guide sheet according to an embodiment of the present invention.

FIG. 4 (a) to (c) are schematic diagrams for describing a production method for a light guide sheet 20A according to an embodiment of the present invention.

FIG. 5 (a) to (d) are schematic diagrams for describing a production method for the light guide sheet 20A according to an embodiment of the present invention (continuing from FIG. 4).

FIG. 6 A schematic diagram for describing another production method for the light guide sheet 20A according to an embodiment of the present invention.

FIGS. 7 (a) and (b) are schematic cross-sectional views for describing problems of a conventional technique.

FIGS. 8 (a) and (b) are schematic cross-sectional views for describing problems of a conventional technique.

FIG. 9 (a) to (c) are schematic cross-sectional views for describing a machining error in a production method for a light guide sheet according to an embodiment of the present invention.

FIG. 10 (a) is a schematic cross-sectional view of a sub-light guide sheet 20p shown in FIGS. 5(c); and (b) and (c) are graphs showing measurement results of surface roughness of surfaces 20s1 and 20s2 of the sub-light guide sheet 20p.

FIGS. 11 (a) and (b) are schematic cross-sectional views showing the construction of a foldable liquid crystal display device 100b, where (a) shows an opened state and (b) shows a folded state.

FIGS. 12 (a) and (b) are schematic cross-sectional views showing the construction of, respectively, other foldable liquid crystal display devices 100c and 100d according to embodiments of the present invention.

FIG. 13 (a) to (c) are schematic diagrams of other liquid crystal display devices 200, 300, and 400 according to embodiments of the present invention.

FIGS. 14 (a) and (b) are schematic diagrams of another liquid crystal display device 500 according to an embodiment of the present invention.

FIG. 15 A schematic cross-sectional view of a liquid crystal display device 900a described in Patent Document 4.

### DESCRIPTION OF EMBODIMENTS

Hereinafter, with reference to the drawings, a light guide sheet according to an embodiment of the present invention and a display device having the light guide sheet will be described. However, the present invention is not limited to the illustrated embodiments.

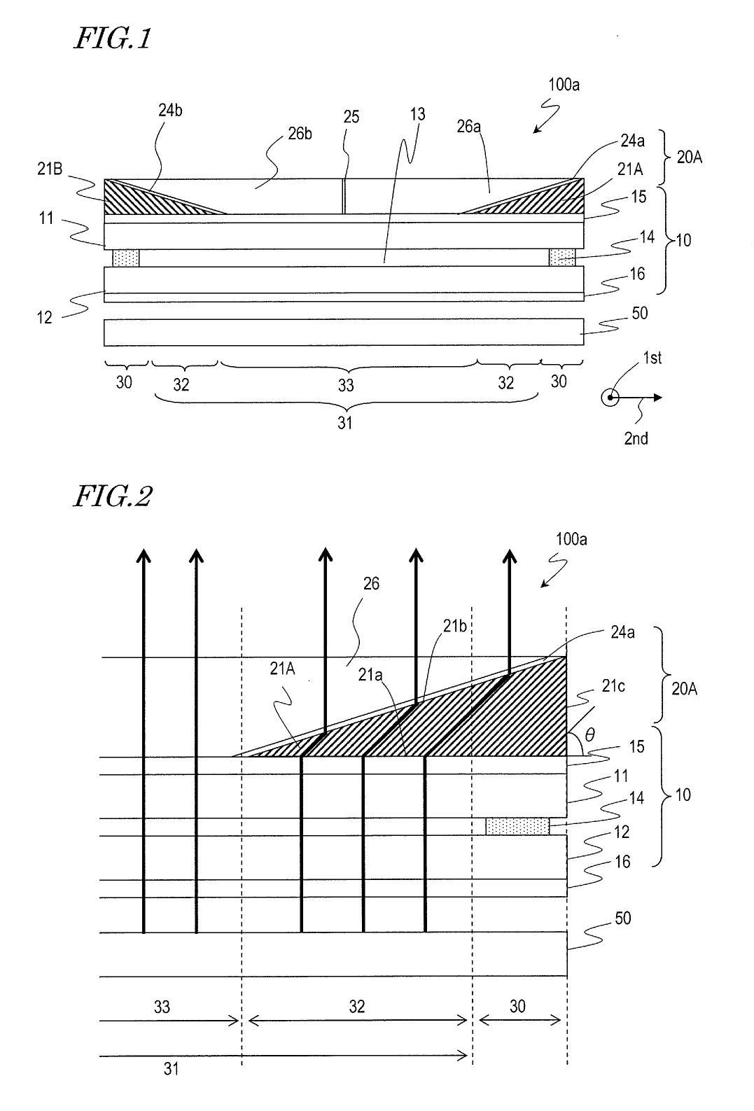

First, with reference to FIG. 1 and FIG. 2, the construction and operation of the display device 100a according to an embodiment of the present invention will be described. Although a liquid crystal display device in which a liquid crystal display panel is used as the display panel is illustrated herein, this is not a limitation; a display panel for PDP, an organic EL display panel, an electrophoresis display panel, or the like can be used.

FIG. 1 is a schematic cross-sectional view of the liquid crystal display device 100a according to an embodiment of the present invention. FIG. 2 is a schematic cross-sectional view of an end portion of the liquid crystal display device 100a. In FIG. 1 and FIG. 2, a direction which is perpendicular to the plane of the figure is defined as a first direction, and a direction which is parallel to the plane of the figure and horizontal is defined as a second direction.

As shown in FIG. 1, the liquid crystal display device 100a includes a liquid crystal display panel 10 and a light guide sheet 20A disposed on the viewer's side of the liquid crystal display panel 10. The liquid crystal display device 100a, which is a transmission type, further includes a backlight device 50, and performs displaying by allowing light which is emitted from the backlight device 50 to be modulated through the liquid crystal display panel 10. The liquid crystal display device 100a may be used alone by itself, or a large-sized liquid crystal display device which is tiled with a plurality of liquid crystal display devices 100a may be obtained. Note that tiling may be achieved by known methods.

The liquid crystal display panel 10 may be any known arbitrary liquid crystal display panel, and is a TFT liquid crystal display panel of the VA mode, for example. The liquid crystal display panel 10 includes a counter substrate 11 on which color filters and a counter electrode are formed, a TFT substrate 12 on which TFTs and pixel electrodes are formed, and a liquid crystal layer 13 which is sealed between the pair of substrates 11 and 12 by a sealing portion 14. On the surfaces of the substrates 11 and 12 that are opposite from the liquid crystal layer 13, optical film portions 15 and 16 are respectively formed, each of which includes a polarizer and an optionally-provided phase plate.

The liquid crystal display panel 10 includes a display region 31 composed of a plurality of pixels arranged in a matrix, and a frame region 30 formed outside the display region 31. The frame region 30 includes regions where the sealing portion 14, terminals of various wiring lines, driving circuit, and the like are formed. Generally speaking, a light shielding film is provided in the frame region 30. Therefore, the frame region 30 does not contribute to displaying.

As the backlight device 50, those which are known are broadly applicable. For example, a direct-type backlight device in which a plurality of cold-cathode tubes are in parallel arrangement can be used.

The light guide sheet 20A includes light guide elements 21A and 21B and light-transmitting cover sheet 26a and 26b. The light guide element 21A and the light-transmitting cover sheet 26a are coupled together via an adhesion layer 24a, whereas the light guide element 21B and the light-transmitting cover sheet 26b are coupled together via an adhesion layer 24b. Moreover, the light-transmitting cover sheets 26a and 26b are coupled together via an adhesion layer 25. Herein, the portion including the light guide element 21A, the light-transmitting cover sheet 26a, and the adhesion layer 24a, and the portion including the light guide element 21B, the light-transmitting cover sheet 26b, and the adhesion layer 24b, may be referred to as sub-light guide sheets. In other words, the light guide sheet 20A may occasionally be said to have a structure in which two sub-light guide sheets are coupled together via the adhesion layer 25.

The light guide element 21A has: a light-receiving surface 21a (first face) and a side face 21c (second face) which are parallel to the first direction and substantially orthogonal to each other; an outgoing surface 21b (third face) being formed between the light-receiving surface 21a and the side face 21c and constituting an acute angle (e.g., 20°) with the light-receiving surface 21a; and two side faces (fourth face and fifth face) substantially orthogonal to the light-receiving surface 21a, the outgoing surface 21b, and the side face 21c. The fourth face and the fifth face are faces that are parallel to the plane of the figure, each having a shape of a right triangle. In other words, a cross sectional shape of the light guide element 21A along the second direction is a right triangle which is defined by the light-receiving surface 21a, the outgoing surface 21b, and the side face 21c. A plurality of light guide paths are formed between the light-receiving surface 21a and the outgoing surface 21b and between the light-receiving surface 21a and the side face 21c. The direction in which the plurality of light guide paths extend is 45° with respect to the light-receiving surface 21a, for example.

The light-transmitting cover sheet 26a has: a first principal face (light-receiving surface) and a second principal face (outgoing surface) which are parallel to the first direction and parallel to each other; a first side face which is a side face being formed between the first principal face and the second principal face and constituting an acute angle with the second principal face; and a second side face and a third side face which are substantially orthogonal to the first principal face, the second principal face, and the first side face. The light-transmitting cover sheet 26a is formed of a transparent resin plate (e.g., an acrylic resin plate), for example.

The first side face of the light-transmitting cover sheet 26a and the outgoing surface 21b of the light guide element 21A are coupled together via the adhesion layer 24a, such that the angle constituted by the outgoing surface and the first side face of the light-transmitting cover sheet 26a is equal to the angle constituted by the light-receiving surface 21a and the outgoing surface 21b of the light guide element 21A. In other words, the sub-light guide sheet which is composed of the light guide element 21A, the adhesion layer 24a, and the light-transmitting cover sheet 26a has a substantially plate-like shape, with a rectangular cross section (the cross section shown in FIG. 1).

The light-receiving surface 21a of the light guide element 21A and the light-receiving surface (first principal face) of the light-transmitting cover sheet 26a are connected via a level difference of 10 μm or less. The reason is that, as will be described later with reference to FIG. 5, the sub-light guide sheet is produced by cutting out, e.g. with a wire saw, a laminate to become the light guide element 21A and the light-transmitting cover sheet 26a while these are coupled together via the adhesion layer 24a, and that this cut surface or a face obtained by subjecting the cut surface to processing such as polishing becomes the light-receiving surfaces of the light guide element 21A and the light-transmitting cover sheet 26a. Similarly, among the surfaces of the light guide sheet 20A (or sub-light guide sheet), in any face that is composed of a cut surface or a face obtained by subjecting the cut surface to processing such as polishing, a face of the light guide element and a face of the light-transmitting cover sheet are connected with a level difference of 10 μm or less. Typically, every surface of the light guide sheet 20A (or sub-light guide sheet) is composed of a cut surface or a face obtained by subjecting the cut surface to processing such as polishing.

The light guide element 21B is disposed so as to be plane-symmetric to the light guide element 21A with respect to a plane which is orthogonal to the second direction (a plane which is parallel to the adhesion layer 25), and its structure and function are the same as those of the light guide element 21A. Moreover, the light-transmitting cover sheet 26b is disposed so as to be plane-symmetric to the light-transmitting cover sheet 26a with respect to a plane which is orthogonal to the second direction (a plane which is parallel to the adhesion layer 25), and its structure and function are the same as those of the light-transmitting cover sheet 26a. In other words, by placing the sub-light guide sheet which is composed of the light guide element 21A, the adhesion layer 24a, and the light-transmitting cover sheet 26a in a plane-symmetric position with respect to a plane which is orthogonal to the second direction (a plane which is parallel to the adhesion layer 25), the sub-light guide sheet which is composed of the light guide element 21B, the adhesion layer 24b, and the light-transmitting cover sheet 26b will be obtained. It will be appreciated that the light-receiving surface of the light guide element 21B and the light-receiving surface (first principal face) of the light-transmitting cover sheet 26b are connected via a level difference of 10 μm or less, similarly to the above.

Thus, the light guide sheet 20A is composed by coupling together two sub-light guide sheets via the adhesion layer 25, the two sub-light guide sheets having substantially plate-like shapes. By disposing the light guide sheet 20A at a predetermined position on the viewer's side of the liquid crystal display panel 10, the frame region of the liquid crystal display panel 10 can be obscured. Note that the light guide sheet according to the embodiment of the present invention is not limited to this example, and the aforementioned sub-light guide sheet may be used alone by itself as a light guide sheet.

Now, with reference to FIG. 2, the reason why the frame region 30 of the liquid crystal display panel 10 is obscured in the liquid crystal display device 100a will be described.

As shown in FIG. 2, the light-receiving surface 21a of the light guide element 21A is disposed so as to overlap a portion 32 of a peripheral display region which adjoins the frame region 30 of the liquid crystal display panel 10 along the horizontal direction, and be parallel to the surface of the liquid crystal display panel 10. The outgoing surface 21b of the light guide element 21A extends to a position where it overlaps the frame region 30, such that its distance from the light-receiving surface 21a increases from the portion 32 of the peripheral display region toward the frame region 30 along the horizontal direction. In particular, as is illustrated herein, it is preferable that the outgoing surface 21b extends to a position where it meets an end of the liquid crystal display panel 10.

As is described in Patent Document 4, the light guide elements 21A and 21B are optical fiber face plates composed of a group of optical fibers, for example. As is well known, each optical fiber includes a core and a cladding, such that light propagates within the core. That is, the core of each fiber functions as one light guide path. Light which enters the light guide element 21A through the light-receiving surface 21a propagates within the optical fiber in parallel to the side face 21c, and goes out at the outgoing surface 21b toward the viewer's side. Since the outgoing surface 21b is disposed so as to overlap the frame region 30 of the liquid crystal display panel 10, the liquid crystal display device 100a allows the region corresponding to the frame region 30 of the liquid crystal display panel 10 to be utilized for displaying.

The optical fiber face plates to be used as the light guide elements 21A and 21B can be produced by, from an optical fiber face plate which has been formed in a plate shape, cutting out their light-receiving surface and outgoing surface so as to define a triangular prism, obliquely with respect to the length direction of the optical fibers. For example, an optical fiber face plate made of quartz (e.g., whose core has a refractive index of 1.8 and whose cladding has a refractive index of 1.5) can be suitably used. Of course, as the refractive index difference between the core and the cladding increases, the numerical aperture (NA) of the optical fibers will increase, which is preferable because of increased light transmittance; however, there is no particular limitation. The material of the optical fibers is not particularly limited, and a transparent resin material such as an acrylic resin may be used. Moreover, it will be more preferable, in terms of preventing blurs in the displayed image, to adopt a fiber face plate having optical absorbers which prevent light leaking from one core from being transmitted to an adjacent core.

Since an optical fiber face plate is expensive, it is preferable to use a laminate having a plurality of light guide layers. A production method for light guide elements 21A and 21B composed of laminates will be described later.

As described above, the light-receiving surface 21a of the light guide element 21A is disposed so as to overlap the portion 32 of the peripheral display region, which adjoins the frame region 30 of the liquid crystal display panel 10 along the second direction. Therefore, light going out from the portion 32 of the peripheral display region enters into the light guide element 21A at the light-receiving surface 21a, propagates through each light guide path (e.g., optical fiber or light guide layer), and goes out from the outgoing surface 21b. Since the outgoing surface 21b is not parallel to the light-receiving surface 21a, but is formed so that its distance from the light-receiving surface 21a increases toward the frame region 30, the displaying light entering at the light-receiving surface 21a (image information) goes out from the outgoing surface 21b with enlargement. Therefore, the user of the liquid crystal display device 100a will be observing an image which is displayed essentially across the entire surface, including the non-display region 30 of the liquid crystal display panel 10.

Note that, as can be seen from FIG. 2, an image which is displayed in the portion 32 of the peripheral display region of the liquid crystal display panel 10 is enlarged along the second direction by the light guide element 21A, so as to be displayed in a region combining the portion 32 of the peripheral display region and the frame region 30. Therefore, in order to achieve natural displaying, it is preferable that the image to be displayed in the portion 32 of the peripheral display region is compressed in advance in accordance with a ratio by which enlargement is applied by the light guide element 21A.

For similar reasons, the luminance of the portion of the peripheral display region of the liquid crystal display panel 10 lowers in accordance with the rate of enlargement. Moreover, the luminance lowers because of the aperture ratio of the light guide element 21A (corresponding to the aperture ratio of the core of each optical fiber) and transmission loss. Therefore, a difference in luminance occurs between a region 33 where the light guide element 21A is not provided and the portion 32 of the peripheral display region where the light guide element 21A is disposed. In order to prevent this, it is preferable to increase the luminance of displaying light going out from the portion 32 of the peripheral display region relative to that in any other display region 33. As for a specific method for these, the method described in Patent Document 4 can be adopted. It is particularly preferable to adopt a method where, by using a liquid crystal display panel having a plurality of pixels which are arrayed across the entire display region with a predetermined pitch, display signals to be supplied to a number of pixels existing in a portion of the peripheral display region are compressed along the second direction.

In the case where the liquid crystal display device 100a is used alone by itself, a display device whose frame region is absent or narrower than the frame region 30 of the liquid crystal display panel 10 can be obtained. It will be appreciated in this case that, without being limited to providing the light guide elements 21A and 21B in the two opposite frame regions along the horizontal direction as illustrated herein, a construction may be adopted where light guide elements 21A and 21B are also provided in the other two opposite frame regions along the vertical direction, such that the frame region is absent or narrowed along all of the four sides of the liquid crystal display device 100a. Moreover, depending on the usage of the liquid crystal display device 100a, a light guide element(s) 21A may be provided along one side, or along any arbitrary two or three sides.

Next, with reference to FIG. 3 to FIG. 6, a production method for the light guide sheet 20A will be described.

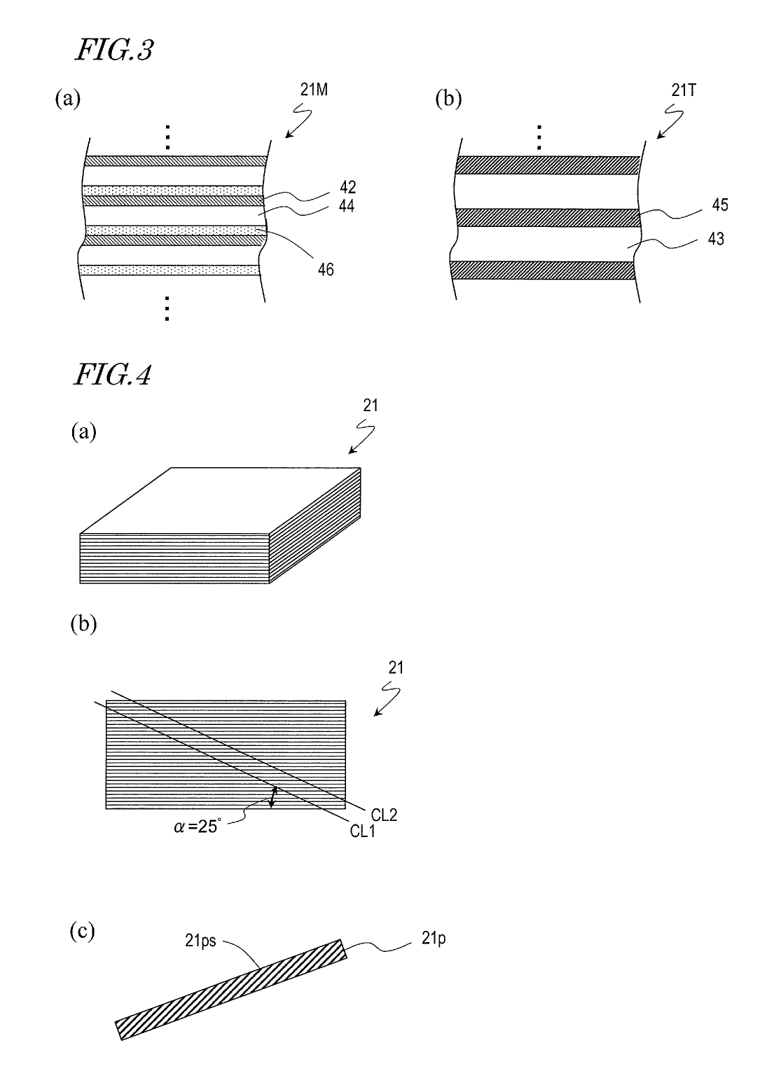

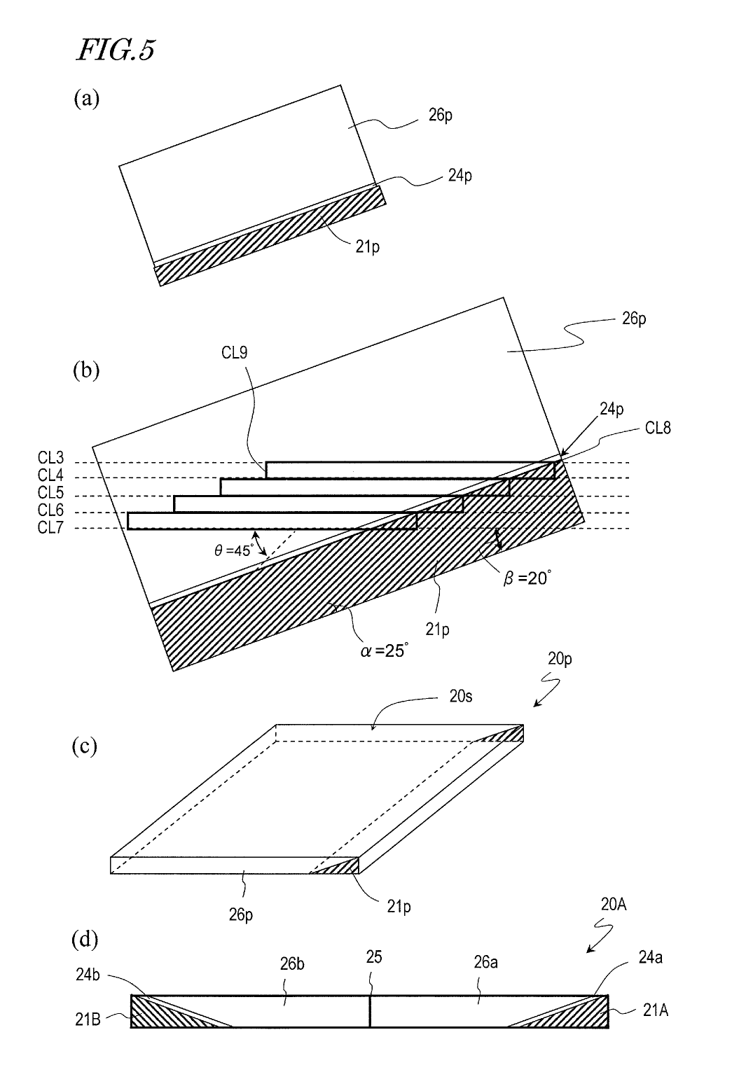

First, as shown in FIG. 4(a), a laminate (bulk light guide) 21 from which to form the light guide element 21A of the light guide sheet 20A is provided. Although a fiber face plate can be used as the bulk light guide 21, it is preferable to use a laminate 21M or 21T of light guide layers shown in FIGS. 3(a) and (b).

The laminate 21M of light guide layers shown in FIG. 3(a) includes a plurality of metal layers 42, a plurality of transparent layers (also referred to as light-transmitting layers) 44, and a plurality of adhesion layers 46. The laminate 21M can be formed in the following manner, for example.

First, a transparent polymer film (e.g., a PET film having a thickness of 100 μm) to become the transparent layer 44 is provided. Thereupon, a silver layer having a thickness of 100 nm, for example, to become the metal layer is formed by vacuum evaporation technique, for example. Thereupon, an adhesion layer 46 having a thickness of e.g. 3 μm is formed by using a hot melt adhesive (thermoplastic resin), for example. A plurality of sheets obtained in this manner (polymer film/silver layer/adhesive) are stacked and pressed together. Thereafter, the hot melt adhesive is melted in an oven at 140° C., for example, thus allowing the sheets to adhere to one another, whereby the laminate 21M is obtained.

The laminate 21T shown in FIG. 3(b) includes two kinds of light-transmitting layers 43 and 45 having different refractive indices from each other. It will be appreciated that three kinds of light-transmitting layers having different refractive indices from one another may be stacked. The laminate 21T can be formed in the following manner, for example.

For example, a transparent polymer film to become the light-transmitting layer 43 (e.g., an acrylic resin film having a thickness of 100 μm) is provided. On one surface of this polymer film, a resin (a resin containing a fluorine-type compound, e.g., Opster (trade name) manufactured by JSR Corporation) having a smaller refractive index than the refractive index of the polymer film is applied, and allowed to dry and cure, whereby the light-transmitting layer 45 is formed. At this time, if the material composing the light-transmitting layers 45 has adhesiveness (including tackiness), it may be allowed to cure in a state where it is stacked with the other light-transmitting layers 43. In the case where the material composing the light-transmitting layers 45 does not have adhesiveness (including tackiness), adhesion layers may be allowed to exist between light-transmitting layers 43 and 45, as in the case of the laminate 21M. The laminate 21T is preferably formed through a roll-to-roll process, as described in Patent Document 4.

Similarly to optical fibers, the laminate 21T guides light by utilizing total reflection at interfaces between the light-transmitting layers 43 and the light-transmitting layers 45, which have a lower refractive index than do the former. The light-transmitting layers 43 correspond to cores, whereas the light-transmitting layers 45 having a lower refractive index correspond to claddings. On the other hand, the laminate 21M utilizes reflection (metallic reflection) at the surfaces (interfaces with the light-transmitting layers 44) of the metal layers 42. Total internal reflection occurs only when light enters a cladding from a core at an angle which is equal to or greater than the critical angle, whereas metallic reflection occurs irrespective of the incident angle. Therefore, the laminate 21M provides an advantage of higher efficiency of light utility over the laminate 21T (however, the efficiency of utility may be low when the metal layers have a low light reflectance). Another advantage of using the laminate 21M is the broad range of materials to select from in forming the light-transmitting layers 44.

Next, as shown in FIG. 4(b), cutting is conducted along cut lines (cut surfaces) CL1 and CL2, which constitute a predetermined angle α with the bedding planes of the laminate 21, whereby a plate-like laminate member 21p having a predetermined thickness is cut out from the laminate 21. For example, the cut lines CL1 and CL2 are in directions at 25° (α=25°) with respect to the bedding planes. Cutting of the laminate 21 can be performed by using known various cutting methods. For example, a laser cutting technique or the like can be used, but it is particularly preferable to use a multi-wire saw. A multi-wire saw achieves cutting through the use of a plurality of wires which are in parallel arrangement, and therefore is able to simultaneously cut out a plurality of plate-like laminate members 21p. Use of a wire saw also provides an advantage in that the cutting margin can be reduced as compared to when using a rotary blade or a band blade. As the multi-wire saw, a loose abrasive type may be used, or a fixed abrasive type may be used.

A cut surface 21ps of the laminate member 21p is subjected to processing such as polishing as necessary. The face to be subjected to processing such as polishing is to be selected as appropriate, according to the need. Moreover, as necessary, the surface of the laminate member 21p may be cleaned and dried.

Next, as shown in FIG. 5(a), a light-transmissive sheet 26p from which to form the light-transmitting cover sheet 26a is coupled to the laminate member 21p via an adhesion layer 24p. The light-transmissive sheet 26p is an acrylic resin sheet, for example. In the case where cleaning is to be conducted after cutting, it is preferable to use an adhesive having water resistance. In the case where cutting oil is employed during cutting, it is preferable to use an adhesive having oil resistance. For example, an instant adhesive TB7737 manufactured by ThreeBond Co., Ltd. can be suitably used.

Next, as shown in FIG. 5(b), cutting is conducted along cut lines (cut surfaces) CL3 to CL7, which constitute a predetermined tilt angle θ (e.g., 45°) with the bedding planes of the laminate 21. At this time, the angle β between the surface of the laminate member 21p and the cut lines (cut surfaces) CL3 to CL7 is 20°, such that the relationship θ=α+β holds. Therefore, the angle β of the cut lines CL3 to CL7 may be set on the basis of the surface of the laminate member 21p. This cutting step is also preferably conducted by using a multi-wire saw. As will be described later with reference to experimental examples, the level difference between the cut surface of the laminate member 21p and the cut surface of the light-transmissive sheet 26p is suppressed to 10 μm or less. Thus, by cutting the laminate member 21p and the light-transmissive sheet 26p while these are previously coupled via the adhesion layer 24p, the level difference at the cut surface can be reduced.

Next, each plate-like sheet member that has been cut out along the cut lines CL3 to CL7 is cut along cut lines CL8 and CL9, whereby a sub-light guide sheet 20p as shown in FIG. 5(c) is obtained. This cutting step is easier performed by a cutting method using a cutting blade or a laser than using a multi-wire saw. The cut surface 20s of the sub-light guide sheet 20p is subjected to processing such as polishing as necessary. The face to be subjected to processing such as polishing is to be selected as appropriate, according to the need. Moreover, as necessary, the surface 20s of the sub-light guide sheet 20p is cleaned and dried.

By allowing two resultant sub-light guide sheets 20p to be coupled via the adhesion layer 25 at side faces of the light-transmitting cover sheets 26a, the light guide sheet 20A which is included in the liquid crystal display device 100 shown in FIG. 1 is obtained.

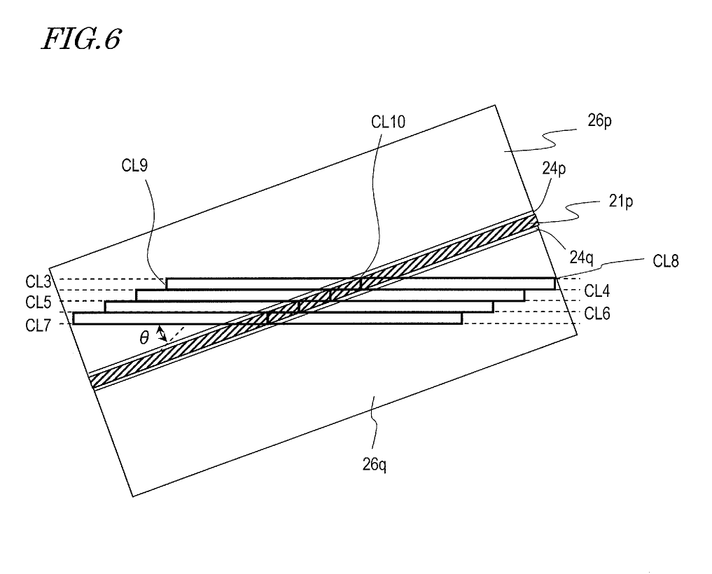

In the production method for the light guide sheet 20A described above, as shown in FIG. 5(a), the light-transmissive sheet 26p adheres to one face of the laminate member 21p. Alternatively, as shown in FIG. 6, there may be light-transmissive sheets 26p and 26q adhering to both sides of the laminate member 21p via adhesion layers 24p and 24q. After cutting the mutually-adhering laminate member 21p and light-transmissive sheets 26p and 26q along cut lines CL3 to CL7, they may be cut along CL8 and CL9 and further along cut line CL10, whereby a sub-light guide sheet 20p as shown in FIG. 5(c) is obtained.

As will be clear from a comparison between FIG. 5(b) and FIG. 6, adopting the method of FIG. 6 can significantly enhance the efficiency of utility of the laminate member 21p.

Although a production method for the light guide sheet 20A (see FIG. 2) whose light guide layers have a tilt angle θ of 4.5° with respect to the light-receiving surface 21a has been illustrated here as an example, it will be appreciated that the structure of the light guide sheet 20A according to the embodiment of the present invention is not limited to the illustrated structure, but the tilt angle θ and the like of the light guide layers may be appropriately changed as necessary.

Now, with reference to FIG. 15, advantages of the liquid crystal display device 100a according to the embodiment of the present invention over a liquid crystal display device 900a described in Patent Document 4 will be described.

In the liquid crystal display device 900a shown in FIG. 15, the structure of a light guide sheet 90A differs from that of the light guide sheet 20A of the liquid crystal display device 100a. Since there is no difference in the structure of the liquid crystal display panel 10 and the backlight device 50, they are denoted by like reference numerals, and the descriptions thereof will be omitted.

As shown in FIG. 15, the liquid crystal display device 900a described in Patent Document 4 includes two light guide elements 91A and 91B and a light-transmitting cover 96 which covers a display region 31 of the liquid crystal display panel 10 and outgoing surfaces 91b of the two light guide elements 91A and 91B. The light guide element 91A has an incident surface 91a, the outgoing surface 91b, and a plurality of light guide paths formed between the incident surface 91a and the outgoing surface 91b, such that a cross sectional shape of the light guide element 91A along the second direction is a triangle which is defined by the incident surface 91a, the outgoing surface 91b, and a side face 91c. The light guide element 91A extends along a direction which is perpendicular to the plane of the figure, with an overall shape which is a triangular prism.

The light guide element 91A and the cover 96 are provided as separate members, and the cover 96 and the light guide element 91A are fixed to the surface of the liquid crystal display panel 10 by a transparent adhesive layer not shown. The light guide element 91A is further fixed by a resin layer 95 which is formed between the side face 91c and the surface of the liquid crystal display panel 10.

Each triangle with the cross section shown in FIG. 15 is an isosceles triangle having a vertex angle of about 150° and base angles of about 20°. It is difficult to fabricate a triangular prism having such a cross-sectional shape with a high dimensional accuracy. Moreover, there is also a problem in that chipping is likely to occur at the corner portions, in particular at the base angles, during the production steps (e.g., cutting-out steps).

A specific example size of the light guide element 21A included in the light guide sheet 20A shown in FIG. 1 will be illustrated. For example, in the case where a panel of a 3.8 type (i.e., the display region 31 has a diagonal length of 3.8 inches) in which the frame region 30 has a width of 1.2 mm and the portion 32 of the peripheral display region has a width of 2.1 mm is used as the liquid crystal display panel 10, the light guide element 21A will be a triangular prism whose cross-sectional right triangle shown in FIG. 1 and FIG. 2 has a base length (i.e., length of the light-receiving surface 21a) of 3.3 m, a height (i.e., length of the side face 21c) of 1.2 mm and a length along the first direction (i.e., length along a direction which is perpendicular to the plane of the figure of FIG. 1) of 85 mm. This indicates that the light guide element 21A is a small and elongate triangular prism, which will be difficult to handle if provided as a separate member.

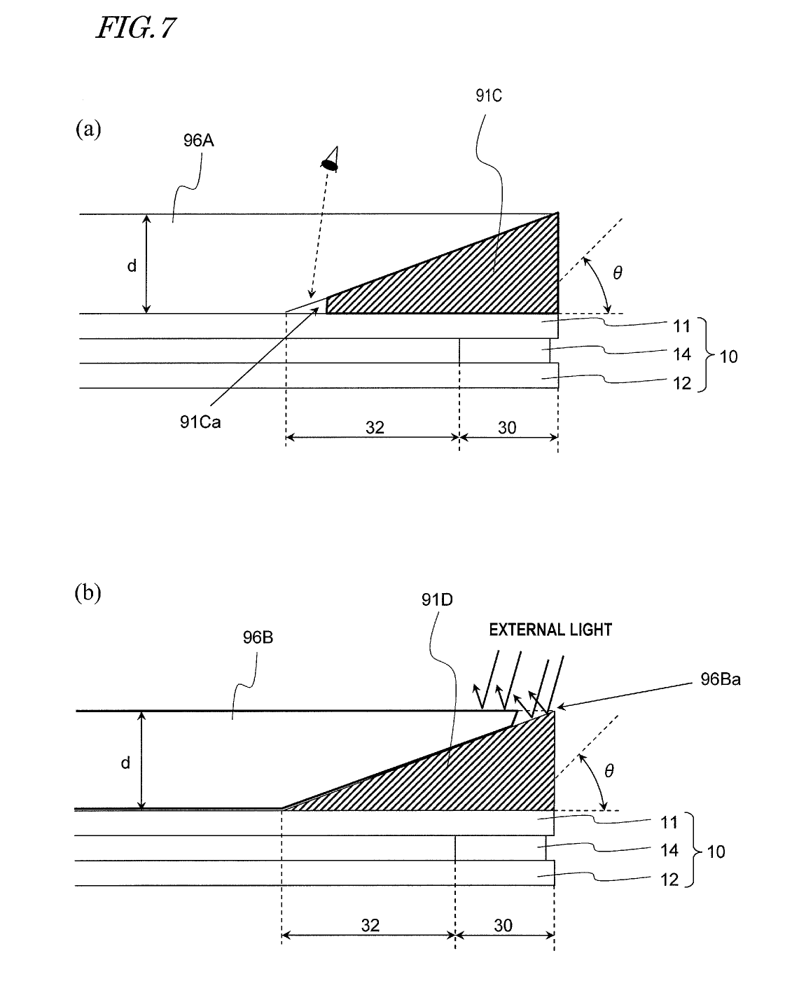

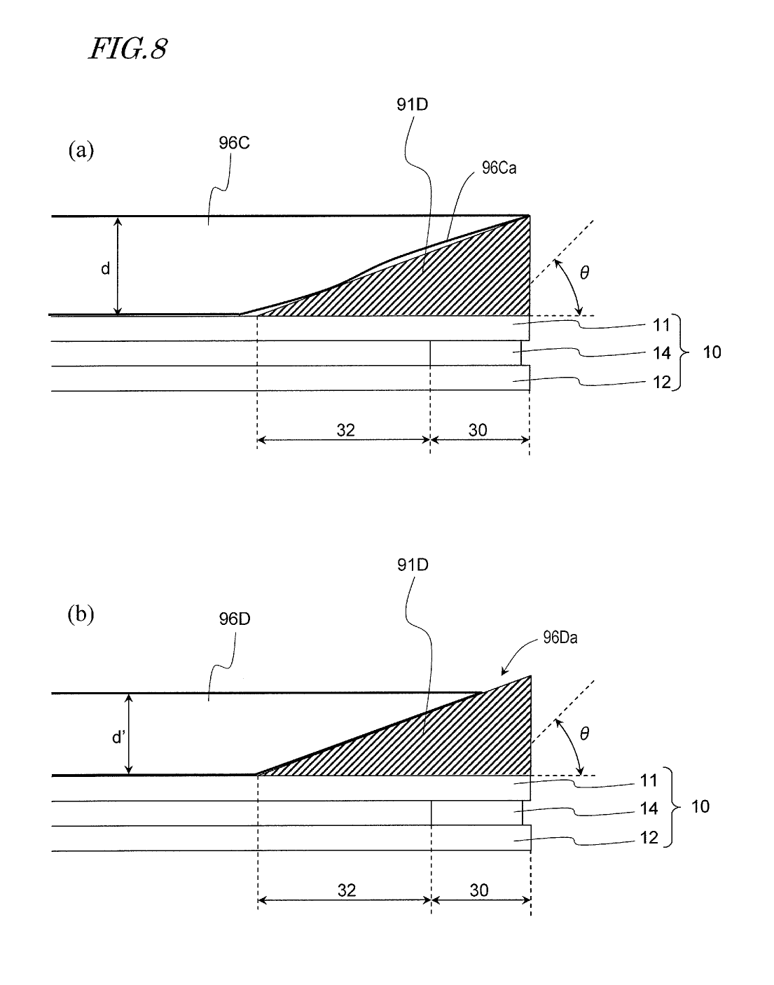

With reference to FIG. 7 and FIG. 8, examples of how specific problem may occur will be described.

FIG. 7(a) shows a problem in the case where a chipping 91Ca occurs in an acute angle portion of a light guide element 91C. If a chipping (e.g., about 0.5 mm) occurs in an acute angle portion of the light guide element 91C, an air gap will emerge between the light-transmitting cover sheet 96A and the light guide element 91C. Since the air within the air gap has a refractive index as small as 1, the reflectance at the interface between the light-transmitting cover sheet 96A and the air gap will be greater than in any other portion, thus lowering the display quality. Moreover, as described in Patent Document 4, in the case where a compressed image is being displayed in the portion 32 of the peripheral display region in order to accommodate the image enlargement introduced by the light guide element 91C, the viewer will be seeing the compressed image through the portion of chipping 91Ca, thus feeling oddness.

On the other hand, as shown in FIG. 7(b), if a chipping 96Ba occurs in an acute angle portion of a light-transmitting cover sheet 96B, a level difference will be formed on the viewer-side surface of the light-transmitting cover sheet 96B (i.e., the chipping portion will be dented), so that the light which is reflected by the portion of level difference will be in a different direction from any other portion. This will result in a discontinuous distribution of reflected light intensity, thus causing the viewer to feel oddness. This problem will be particularly outstanding in a bright environment.

Moreover, if the tilted side face 96Ca has low processing accuracy as in a light-transmitting cover sheet 96C shown in FIG. 8(a), an air gap will emerge between the light-transmitting cover sheet 96C and the outgoing surface of a light guide element 91D, will result in a discontinuous distribution of reflectance, thus lowering the display quality. Although a case where the light-transmitting cover sheet 96C has low processing accuracy is illustrated, the same problem will also occur when the light guide element 91D has low processing accuracy. The processing accuracy of the plane of adhesion between the light guide element 91D and the light-transmitting cover sheet 96C at least needs to be on the order of the thickness (1 μm to 50 μm) of the adhesion layer (not shown); if a discrepancy is so large that it cannot be absorbed by the adhesion layer occurs, the aforementioned problem will occur.

On the other hand, as shown in FIG. 8(b), if a light-transmitting cover sheet 96D has a thickness d′ that is smaller than the desired thickness d (which is equal to the height of the light guide element 91D), a level difference will be formed on the viewer-side surface of the light-transmitting cover sheet, which will result in a discontinuous distribution of reflected light intensity, thus causing the viewer to feel oddness. It will be appreciated that similar problems also occurs when the height of the light guide element 91D is greater than the desired height.

Thus, various problems will occur if the light guide elements and the light-transmitting cover sheets are prepared as separate members and then assembled in a manner described in Patent Document 4. On the other hand, in the light guide sheet according to the embodiment of the present invention, the light guide elements and the light-transmitting cover sheets are formed integrally, thus suppressing the aforementioned problems.

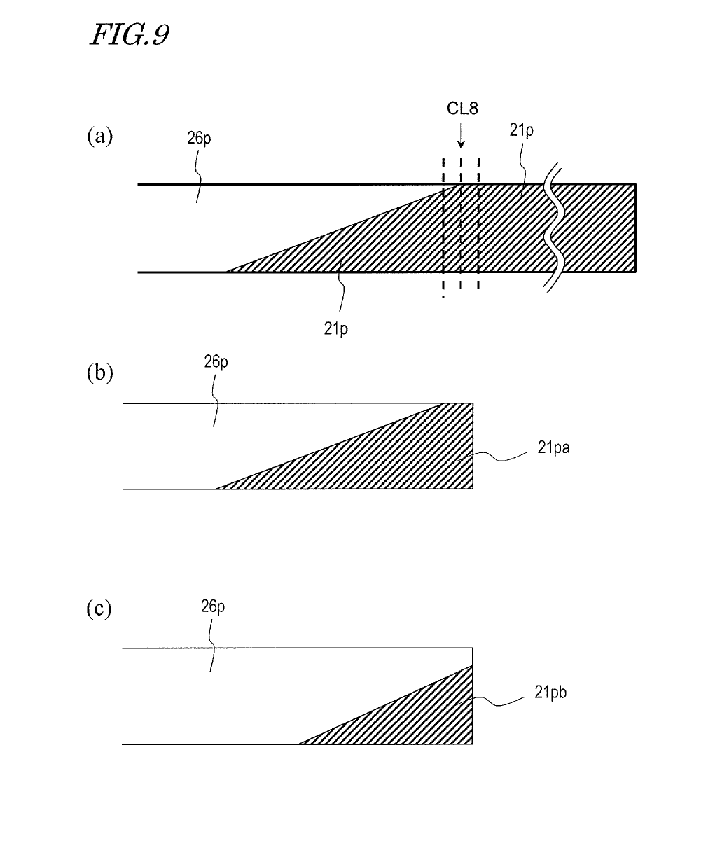

Note that the light guide sheet 20A according to the embodiment of the present invention might also experience machining errors. Machining errors in the cutting step that has been described with reference to FIG. 5(b) will be described with reference to FIGS. 9(a) to (c). In FIGS. 9(b) and (c), deviations in cutting are illustrated with exaggeration.

In the cutting step described with reference to FIG. 5(b), if cutting is carried out at cut line CL8 as shown in FIG. 9(a), the light guide sheet 20A as designed will be obtained.

If the position of the cut line is deviated toward the laminate member 21p as shown in FIG. 9(b), a portion of the light guide element will be exposed at an end portion of the viewer-side surface of the light guide sheet, but no level difference will be formed on the viewer-side surface of the light guide sheet. If the position of the cut line is deviated toward the light-transmitting cover 26p as shown in FIG. 9(c), no level difference will be formed on the viewer-side surface of the light guide sheet, either. Therefore, the oddnesses described with reference to FIG. 7(b) and FIG. 8(b) will not be felt by the viewer. Note that, since errors in the step of cutting along cut line CL8 can easily be suppressed to about ±0.1 mm, influences on the display quality will be within a tolerable range.

Moreover, as has been described above with reference to FIG. 5(a), the attaching of the light guide element and the light-transmitting cover sheet is achieved by using the light-transmissive sheet 26p and the laminate member 21p, which are larger than the light guide element and the light-transmitting cover sheet, and both of the light-transmissive sheet 26p and the laminate member 21p are in the form of rectangular-solid blocks. Therefore, the attaching task is easy, and air gaps as shown in FIG. 7(a) and FIG. 8(a) will not be formed between the light guide element and the light-transmitting cover sheet. Even if an air gap is formed at all, reworking can be easily done.

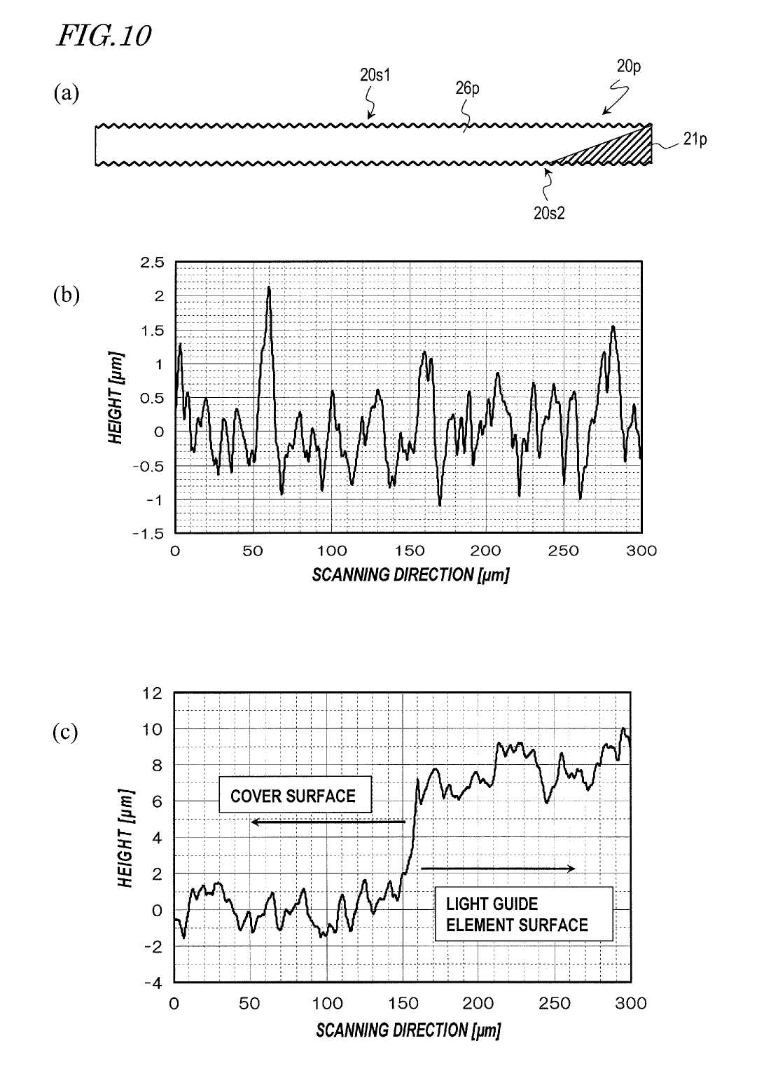

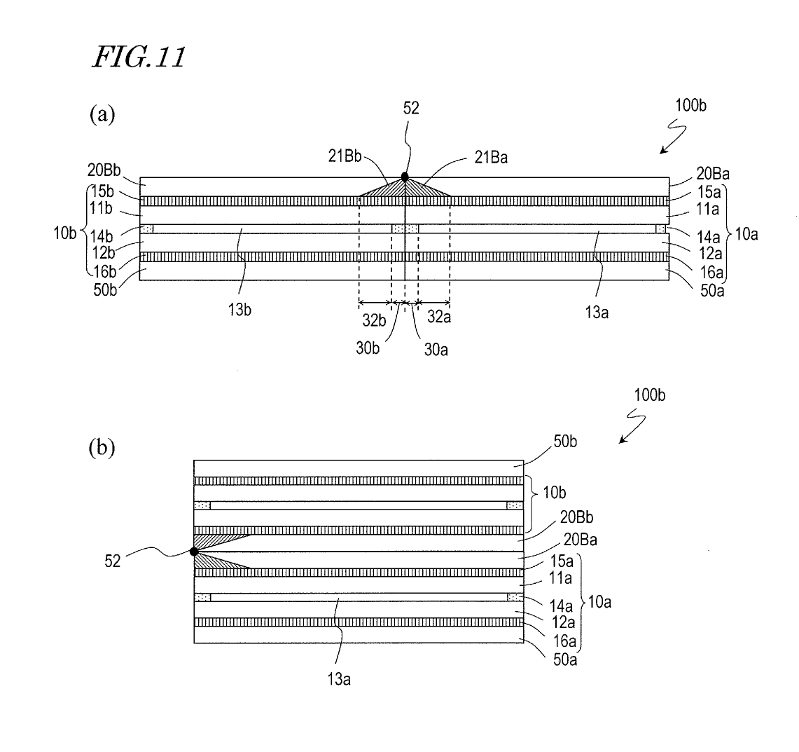

Next, the surface roughness of a face which has been cut by using a multi-wire saw will be described with reference to FIG. 10. FIG. 10(a) is a schematic cross-sectional view of the sub-light guide sheet 20p shown in FIG. 5(c), whereas FIG. 10(b) and FIG. 10(c) are graphs showing measurement results of surface roughness of surfaces 20s1 and 20s2 thereof. Note that surface roughness was measured by using a surface roughness micro surface profiler P-11 (manufactured by KLA-Tencor Corporation).

As can be seen from FIG. 10(b), the surface roughness of the surface 20s1 of the sub-light guide sheet 20p is approximately within a range of ±2.0 μm. As can be seen from FIG. 10(c), the level difference at the interface between the laminate member 21p to become the light guide element and the light-transmissive sheet 26p to become the light-transmitting cover sheet is about 8 μm (10 μm or less), while the roughness of each surface is approximately within a range of ±2.0 μm. Although the level difference is formed on the cut surface because of the laminate member 21p and the light-transmissive sheet 26p being of different materials, the level difference is suppressed to this level by conducting the cutting with the use of a multi-wire saw.

The minute bumps and dents of ±2.0 μm which are formed on the cut surface of the sub-light guide sheet 20p appear whitish and hazy because they cause diffuse reflection (or scatter) of light. In order to prevent this, the cut surface may be mirror finished through polishing or the like (so that the surface roughness is smaller than the order of visible light wavelengths, e.g., less than ±0.2 μm).

However, mirror finishing of the surface 20s2 of the light guide sheet 20p, which is to be attached to the liquid crystal display panel 10 via an adhesion layer, is omissible. The bumps and dents on the surface 20s2 of the light guide sheet 20p can be absorbed by the adhesion layer (not shown) which is formed between the surface 20s2 of the light guide sheet 20p and the surface of the liquid crystal display panel 10. The adhesive which is used for the adhesion layer has a refractive index of about 1.5, and the materials composing the surface 20s2 of the light guide sheet 20p and the surface of the liquid crystal display panel 10 also have a refractive index of about 1.5; thus, these are essentially equal. Of course, the respective materials are preferably selected so as to reduce their refractive index difference. It is also preferable that no air voids are formed in the adhesion layer or at the interface of adhesion.

Similarly, mirror finishing of the viewer-side surface 20s1 of the light guide sheet 20p may also be omitted. In other words, a front face plate having light transmissiveness may be provided on the viewer-side surface 20s1 of the light guide sheet 20p via an adhesion layer. For example, in the case where a touchscreen panel is provided, the film for use as the touchscreen panel can also double as a front face plate, so that diffuse reflection at the viewer-side surface 20s1 of the light guide sheet 20p can be prevented without any increase in the parts and steps. Furthermore, an antireflection film may be formed on the viewer-side surface of the front face plate. The antireflection film will reduce surface reflection of external light and provide for an improved visual recognition. As the antireflection film, a magnesium fluoride (MgF₂) thin film, a film obtained by applying a low-refractive index resin such as an acrylic resin having fluorine added thereto, a moth-eye type antireflection film having minute bumps and dents of sub-wavelength order formed on its surface for reducing surface reflection, or the like can be used.

Hereinafter, with reference to FIG. 11 to FIG. 14, an exemplary liquid crystal display device according to an embodiment of the present invention will be described. Hereinafter, an example of employing a plurality of liquid crystal display panels will be described.

FIGS. 11(a) and (b) are schematic cross-sectional views showing the construction of a foldable liquid crystal display device 100b, where FIG. 11(a) shows an opened state, and FIG. 11(b) shows a folded state.

The liquid crystal display device 100b shown in FIGS. 11(a) and (b) includes two liquid crystal display panels 10a and 10b. One difference from the light guide sheet shown in FIG. 1 is that light guide sheets 20Ba and 20Bb, which are provided on the viewer's side of the respective liquid crystal display panels 10a and 10b, have light guide elements 21Ba and 21Bb provided only at the end at which they adjoin each other (on a hinge rotation axis 52 side).

Since the liquid crystal display device 100b includes the light guide sheets 20Ba and 20Bb, jointless displaying can be realized in an opened state where the display planes of the liquid crystal display panels 10a and 10b are at 180°, as shown in FIG. 11(a). When not in use, it can be folded up as shown in FIG. 11(b) to become compact, thus facilitating transportation.

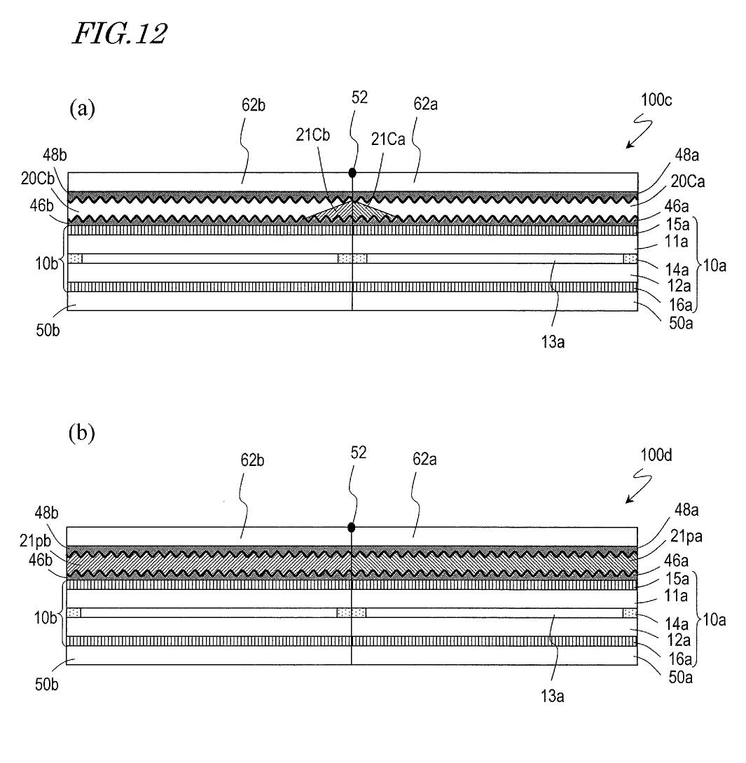

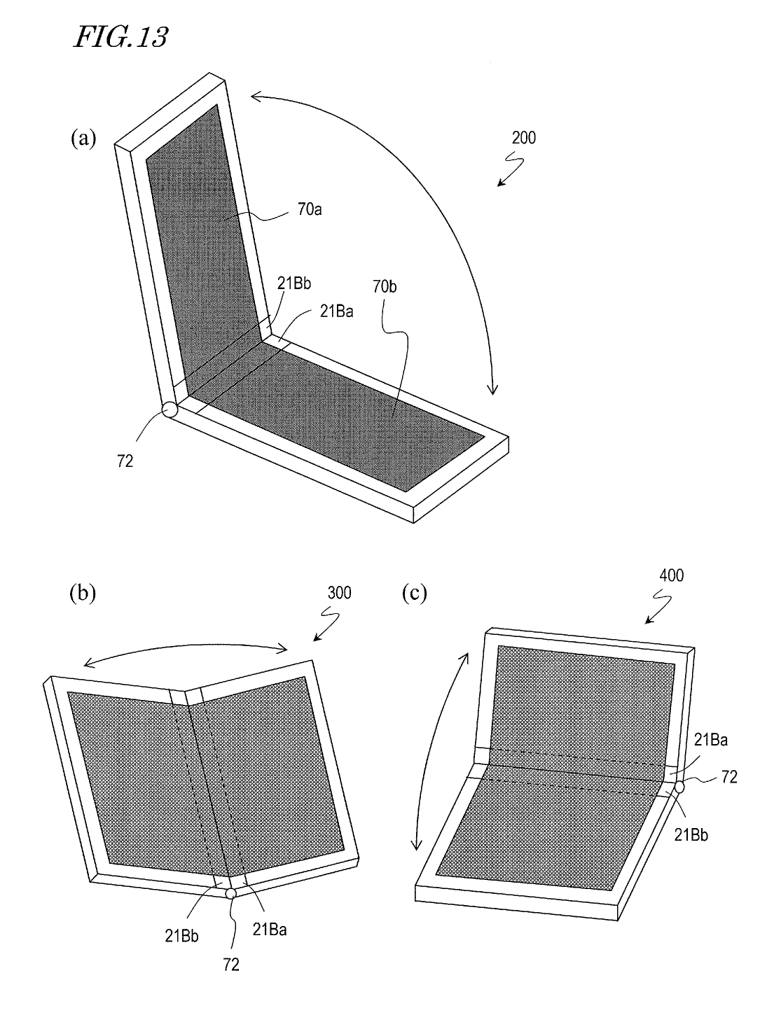

FIG. 12(a) is a schematic cross-sectional view showing the construction of another foldable liquid crystal display device 100c. Both the light-receiving surface (i.e., the face closer to the liquid crystal display panel 10a, 10b) and the outgoing surface of each light guide sheet 20Ca, 20Cb included in the liquid crystal display device 100c are faces having just been cut with a wire saw, and include minute bumps and dents. The light-receiving surfaces of the light guide sheets 20Ca and 20Cb adhere to the liquid crystal display panels 10a and 10b via adhesion layers 46a and 46b, whereby diffuse reflection associated with the minute bumps and dents is prevented. Moreover, the outgoing surfaces of the light guide sheets 20Ca and 20Cb adhere to front face plates 62a and 62b via adhesion layers 48a and 48b, whereby diffuse reflection associated with the minute bumps and dents is prevented. The front face plates 62a and 62b are touchscreen panels, for example.

Note that another foldable liquid crystal display device 100d shown in FIG. 12(b) may also be constructed by using the laminate member 21p which is produced at FIG. 4(c) in the aforementioned production method as each of light guide sheets 21pa and 21pb. Both the light-receiving surface (i.e., the face closer to the liquid crystal display panel 10a, 10b) and the outgoing surface of each light guide sheet 21pa, 21pb included in the liquid crystal display device 100d are faces having just been cut with a wire saw, and include minute bumps and dents. The light-receiving surfaces of the light guide sheets 21pa and 21pb adhere to the liquid crystal display panels 10a and 10b via adhesion layers 46a and 46b, whereby diffuse reflection associated with the minute bumps and dents is prevented. Moreover, the outgoing surfaces of the light guide sheets 21pa and 21pb adhere to the front face plates 62a and 62b via adhesion layers 48a and 48b, whereby diffuse reflection associated with the minute bumps and dents is prevented. The front face plates 62a and 62b are touchscreen panels, for example.

Each of the light guide sheets 21pa and 21pb is entirely a light guide element. Although they are not in triangular prism shape, the principle by which light entering into the light guide element at the light-receiving surface propagates through each light guide path (e.g., optical fiber or light guide layer) and goes out from the outgoing surface is similar to that in the aforementioned triangular prism case. While the light guide sheets 20Ca and 20Cb in FIG. 12(a) have light guide elements 21Ca and 21Cb of triangular prism shape, the light guide sheets 21pa and 21pb of FIG. 12(b) are entirely light guide elements, and therefore the large volumes of these light guide elements provide an advantage of high production efficiency due to a small number of steps in the production process, although the material cost will be high.

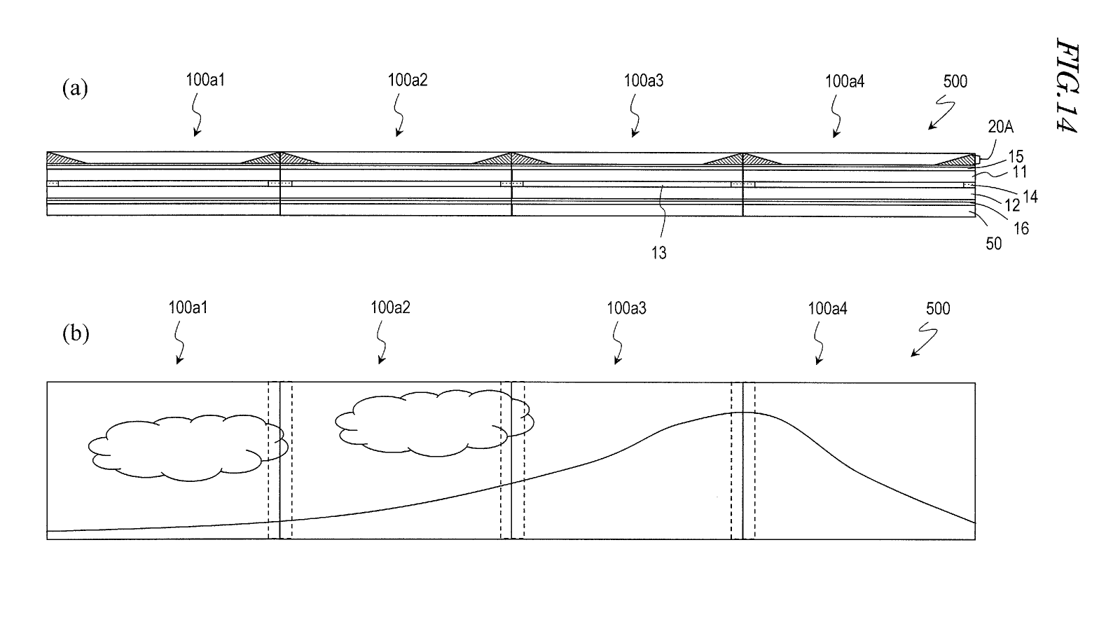

The present invention is applicable to liquid crystal display devices 200, 300, and 400 of various shapes as shown in FIGS. 13(a) to (c). By adopting a movable section which permits rotation around a hinge rotation axis 72 in a portion where two adjoining liquid crystal display panels meet each other, the angle between adjoining display planes 70a and 70b can be made variable. For example, the liquid crystal display device 200 is usable as a mobile phone, the liquid crystal display device 300 as an electronic book, and the liquid crystal display device 400 as a game machine. It will be appreciated that the angle between the two display planes may be fixed. Thus, a liquid crystal display device according to an embodiment of the present invention allows a large-screen display device to be mounted in a small-sized appliance, and therefore is very useful.

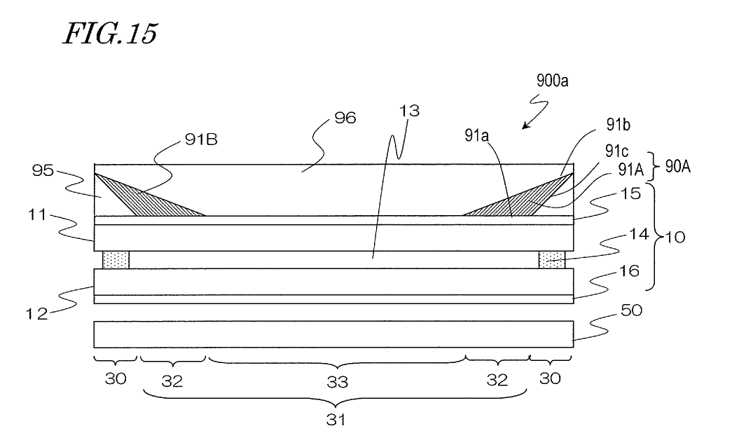

Moreover, as in a liquid crystal display device 500 shown in FIG. 14(a), a plurality of liquid crystal display devices 100a1 to 100a4 may be arranged in one direction. Each of the liquid crystal display devices 100a1 to 100a4 may be identical to the liquid crystal display device 100a shown in FIG. 1, for example. As shown in FIG. 14(b), the liquid crystal display device 500 is able to realize jointless displaying. The liquid crystal display device 500 may be foldable, or the angle between any two adjoining display planes may be fixed at less than 180°.

Although examples illustrated herein employ liquid crystal display panels, self-light-emitting type display panels such as organic EL display panels may be employed instead of liquid crystal display panels, in which case it is needless to say that the backlight device 50 is not needed.

### INDUSTRIAL APPLICABILITY

The present invention is suitably used for various direct-viewing type display devices.

### REFERENCE SIGNS LIST

10 liquid crystal display panel
11 counter substrate
12 TFT substrate
13 liquid crystal layer
14 sealing portion
15, 16 optical film portion
20A light guide sheet
21A light guide element
21a light-receiving surface
21b outgoing surface
21c side face
24a, 24b, 25 adhesion layer
26 cover
30 frame region
31 display region
32 portion of peripheral display region
50 backlight device
100a liquid crystal display device

1. A light guide sheet comprising:
a light guide element having a first face and a second face which are parallel to a first direction and substantially orthogonal to each other, a third face being formed between the first face and the second face and constituting an acute angle with the first face, and a fourth face and a fifth face which are substantially orthogonal to the first face, the second face, and the third face, the light guide element having a plurality of light guide paths formed between the first face and the second face and third face; and
a light-transmitting cover sheet having a first principal face and a second principal face which are parallel to the first direction and parallel to each other, a first side face which is a side face being formed between the first principal face and the second principal face and constituting an acute angle with the second principal face, and a second side face and a third side face which are substantially orthogonal to the first principal face, the second principal face, and the first side face, wherein,
the light guide sheet has a substantially plate-like shape;
the third face of the light guide element and the first side face of the light-transmitting cover sheet are coupled to each other via an adhesion layer;
an angle between the first face and the third face of the light guide element is equal to an angle between the second principal face and the first side face of the light-transmitting cover sheet; and
the first face of the light guide element and the first principal face of the light-transmitting cover sheet are connected via a level difference of 10 μm or less.

2. The light guide sheet of claim 1, wherein the first face of the light guide element and the first principal face of the light-transmitting cover sheet have bumps and dents of 1 μm or more.

3. The light guide sheet of claim 1, wherein the second principal face of the light-transmitting cover sheet has bumps and dents of 1 μm or more.

4. The light guide sheet of claim 1, wherein one of the fourth face and fifth face of the light guide element and the second side face of the light-transmitting cover sheet are connected via a level difference of 10 μm or less, and the other of the fourth face and fifth face of the light guide element and the third side face of the light-transmitting cover sheet are connected via a level difference of 10 μm or less.

5. A light guide sheet comprising two sub-light guide sheets, wherein,
each of the two sub-light guide sheets is the light guide sheet of claim 1, having a fourth side face substantially orthogonal to the first principal face and the second principal face; and
the fourth side faces of the two sub-light guide sheets are coupled to each other via an adhesion layer.

6. A display device comprising:
the light guide sheet of claim 1; and
a display panel having a display region and a frame region formed outside the display region, wherein
the first face of the light guide element is disposed so as to overlap a portion of a peripheral display region and be parallel to an outgoing surface of the display panel, the peripheral display region adjoining the frame region of the display panel along a second direction which is orthogonal to the first direction.

7. The display device of claim 6, wherein,
the first face of the light guide element and the first principal face of the light-transmitting cover sheet have bumps and dents of 1 μm or more; and
the light guide sheet and the display panel are coupled to each other via an adhesion layer.

8. The display device of claim 6, wherein,
the second principal face of the light-transmitting cover sheet has bumps and dents of 1 μm or more;
the display device further comprises a transparent front face plate disposed on a viewer's side of the light guide sheet; and
the light guide sheet and the transparent front face plate are coupled to each other via an adhesion layer.

9. The display device of claim 6, wherein,
the at least one display panel has a plurality of pixels arrayed at a predetermined pitch across the entire display region; and
display signals to be supplied to a number of pixels existing in the portion of the peripheral display region are compressed along the second direction.
